(19) United States
(12) Patent Application Publication
(10) Pub. No.: US 2017/0226850 A1
(43) Pub. Date: Aug. 10, 2017

(54) METHOD FOR DETERMINING A THERMAL CONDUCTIVITY PROFILE OF ROCKS IN A WELLBORE

(71) Applicants: Valery Vasilyevich SHAKO, Domodedovo (RU); SCHLUMBERGER TECHNOLOGY CORPORATION, Sugar Land, TX (US)

(72) Inventors: Valery Vasilyevich SHAKO, Moscow (RU); Vyacheslav Pavlovich PIMENOV, Moscow (RU); Anton Vladimirovich PARSHIN, Ufa (RU)

(21) Appl. No.: 15/037,996

(22) PCT Filed: Nov. 18, 2014
(86) PCT No.: PCT/RU2014/000874

§ 371 Date: May 1, 2017

(30) Foreign Application Priority Data
Nov. 19, 2013 (RU) 2013151155

(51) Int. Cl. E21B 49/00; G01N 25/18; G01K 11/32; E21B 47/06

(52) U.S. Cl. CPC E21B 49/00; E21B 47/065; G01N 25/18; G01K 11/32

(57) ABSTRACT

A casing with temperature sensors attached to its outer surface is lowered into a borehole and a cement slurry is injected into an annulus between the casing and a borehole wall. During injecting and hardening of the cement temperature is measured and thermal conductivity of the rock formation surrounding the borehole is determined.

### BACKGROUND

The invention relates to well logging and can be used for determining thermal properties of rock formations surrounding the boreholes.

Knowledge of thermal properties, in particular, thermal conductivity of a rock formation is needed for simulating and optimizing of oil and gas production, especially for optimizing thermal methods of heavy oil recovery. Formation thermal properties are usually measured in laboratories on core samples extracted from a borehole. Results of heat capacity measurements are quite applicable for simulation of temperature fields of the oil reservoir, but results of thermal conductivity measurements may differ substantially from thermal conductivity of blocks of rock in-situ. This is related to:
changes in properties a core upon drilling;
a difference between laboratory and reservoir RT conditions;
an influence of reservoir fluids properties, which is not always taken into account in laboratory measurements.

A major concern is the representativeness of the results of laboratory measurements. Generally, a core output is significantly below 100%, and laboratory studies do not provide information about properties of fractured interlayers and poorly consolidated rocks (where the core output is small), which could substantially affect thermal conductivity of large blocks of rock that is used in the simulation of reservoirs. Therefore, in addition to laboratory studies on the core, experiments have been carried out for many years to determine thermal properties of rocks in-situ, in the borehole, but up to the present time no method or device suitable for practical use has been developed.

Many different approaches were proposed to determine rock formation thermal conductivity in situ. For example, it was proposed to use a process of recovery of undisturbed temperature of the rock mass after drilling or after well cleanout (see Dakhnov V. N., Diakonov D. I., Thermal Surveys in Wells, 1952, GNTINGTL, Moscow, 128 pages). The disadvantage of this method is that measurement results are strongly dependent on crossflows and free thermal convection of the fluid in a borehole, on a borehole radius and a position of a temperature sensor in the borehole. In addition, it is difficult to accurately simulate thermal disturbance of the rock mass during drilling or flushing the borehole, which is necessary for quantitative interpretation of the measured temperature and evaluation of thermal properties of the rock.

The most part of suggested approaches for formation thermal conductivity evaluation in situ are based on a linear heat source theory. A long enough (3-5 m) electrically heated probe is introduced into a borehole and a rate of temperature rise of the probe is detected, which depends on thermal properties of the surrounding rock (see e.g., Huenges, E., Burhardt, H., and Erbas, K., 1990. Thermal conductivity profile of the KTB pilot corehole. Scientific Drilling, 1, 224-230). Main disadvantages of the method include a long time (about 12 hours) required to measure thermal properties at each section of the borehole, distortions associated with free thermal convection of fluid in the borehole, and the need to supply significant electrical power to the downhole probe.

Some methods utilize small electrically heated probes that are pressed against a wall in a borehole (see Kiyohashi H., Okumura K., Sakaguchi K. and Matsuki K., 2000. Development of direct measurement method for thermophysical properties of reservoir rocks in situ by well logging, Proceedings World Geothermal Congress 2000, Kyushu-Tohoku, Japan, May 28-Jun. 10, 2000). These methods allow reducing measurement time; however they require smooth walls in the borehole, sophisticated equipment, and a complex numerical model for determining thermal properties of rocks from measurements of the probe temperature, and allow estimation of thermal properties of only a very thin (1-3 cm) layer of rock near the borehole walls. This layer was subjected to a mechanical stress released during drilling and may have induced microcracks; pores in the rock are filled with drill fluid, rather than formation fluid, so thermal properties of this layer can differ significantly from the properties of rock away from the borehole.

There are also methods that utilize movable probes. A heat source is arranged at the probe head, and a temperature sensor is disposed at the end of the probe (see, e.g., patent U.S. Pat. No. 3,892,128). These methods allow quick estimation of thermal properties of rocks at a considerable depth interval, however, as in the previous case, they provide information about the properties of only a very thin layer of rock around the borehole.

### SUMMARY

The disclosure provides simultaneous acquisition of information about properties of a relatively thick (about 1 m) layer of a rock formation around a borehole and information about thermal conductivity of the rock formation for the entire depth interval to be grouted; moreover, the disclosure does not require a supply of electrical power in the borehole.

The disclosed method of determining a rock formation thermal conductivity profile comprises lowering a casing with temperature sensors attached to its outer surface into a borehole. Then, a cement slurry is injected into an annulus between the casing and a borehole wall. During said injecting and hardening of the cement temperature in the borehole is measured and thermal conductivity of rock formation surrounding the borehole is determined by the formula:

$$λ ( z ) = \frac{{Q}_{c} \cdot {V}_{a} ( z )}{4 π \cdot C ( z )}$$

where λ(z) is the thermal conductivity of the rock formation at a depth z; Q_{c} is a cement hydration heat; Vₐ(z) is a volume of the annulus per meter of a borehole length at the depth z; C(z) is a coefficient determined by linear regression method with approximation of the dependence of the measured downhole temperature T(z,t) on inverse time t⁻¹ by the asymptotic formula:

T(z,t)=T_{f}(z)+C(z)·t⁻¹

where T_{f}(z) is a temperature of rock at the depth z.

The temperature sensors can be a fiber-optic sensor.

### BRIEF DESCRIPTION OF DRAWINGS

The invention is illustrated by drawings, where

FIG. 1 shows a geometry of a cylindrically symmetric model used in calculations;

FIG. 2 shows results of numerical simulation of the dependence of temperature of the cement slurry on the reverse time elapsed after the hydration start for two values of thermal conductivity of rock.

### DETAILED DESCRIPTION

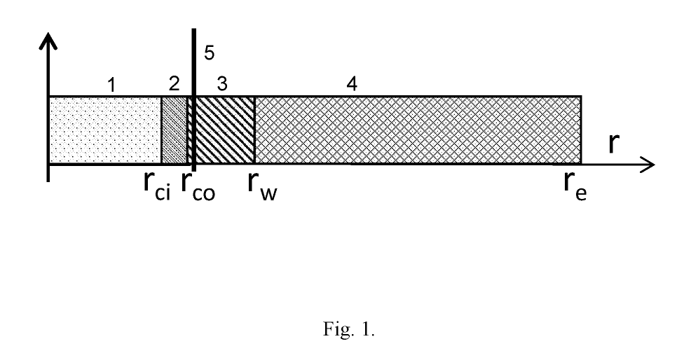

As shown in FIG. 1, for temperature monitoring of the process of injecting and thickening (hydration) of a cement slurry and subsequent temperature monitoring of oil/gas recovery or injection of fluid 1 into a borehole surrounded by a rock formation 4, a casing 2 with attached cable of a fiber temperature sensor 5 is lowered into the borehole.

During thickening of the cement slurry 3 injected into an annulus between the casing 2 and a borehole wall, a significant amount of heat is generated (Q_{c}=100÷200 MJ per 1 m³ of cement). Maximum temperature increase during the thickening of the cement slurry is approximately from 20 to 50° C. The main stage of cement slurry hydration (and heat release) lasts for 30-50 hours, and then a radius of the raised temperature area increases and the temperature in the borehole relaxes to the undisturbed temperature of the rock formation at this depth.

The rate of temperature restoration depends on the amount of an excess heat energy Q per 1 m of the borehole length, and thermal properties of the rock formation surrounding the borehole. The excess thermal energy Q can be found as the product of a cement hydration heat Q_{c} measured in laboratory and an annulus volume, which is determined by an outer radius of the casing r_{co} and a radius of the borehole measured using a caliper and depending on depth z: r_{w}(z). Thus, the rate of temperature recovery in the borehole after hardening is determined solely by the thermal properties of the surrounding rock.

A theoretical model will be described below, which is used as a basis for determining thermal properties of rock formation from the temperature-time relationship measured in the borehole.

A solution of a cylindrically symmetric task of conductive heat transfer on the time evolution of an arbitrary initial temperature distribution in a homogeneous medium is known (see for example, Carslaw H., Jaeger J., 1964. Conduction of Heat in Solids, Moscow, Nauka, p. 88). In a particular case of an initial temperature distribution having the form of a cylinder

$$T ( r , t = 0 ) = \{ \begin{matrix}0 & r > {r}_{0} \\ Δ {T}_{0} & r \leq {r}_{0}\end{matrix} \qquad ( 1 )$$

A temperature-time dependence in the center of the cylinder is as follows:

$$T ( r = 0 , t ) = {T}_{c} ( t ) = Δ {T}_{0} \cdot [ 1 - exp ( - \frac{{r}_{0}^{2}}{4 \cdot a \cdot t} ) ] \qquad ( 2 )$$

where r₀ is a radius of the cylinder, a is a temperature diffusivity of the medium.

At sufficiently large time elapsed after the beginning of temperature restoration (t>>2·r₀²/a), the exponent in formula (2) can be expanded into a series, and the expression for temperature on a cylinder axis will take the form:

$${T}_{c} ( t ) \approx \frac{Δ {T}_{0} \cdot {r}_{0}^{2}}{4 \cdot a \cdot t} , \qquad ( 3 )$$

This formula can be written in the form of the general law of conservation of energy (by multiplying the numerator and denominator of (3) by factor π·ρc):

$${T}_{c} ( t ) \approx \frac{Q}{4 π \cdot ρ c \cdot a \cdot t} = \frac{Q}{4 π \cdot λ \cdot t} \qquad ( 4 )$$

where Q=πr₀²·ρc·ΔT₀ is the amount of excess heat energy in the medium, λ and ρc are thermal conductivity and volumetric heat capacity of the medium.

Numerical experiments show that the generalized asymptotic formula (4) is valid for any initial distribution of temperature. In this case r₀ is the characteristic size of the area, in which the initial temperature is substantially different from the ambient temperature, and requires the condition:

$$t >> \frac{2 \cdot {r}_{0}^{2}}{a} \qquad ( 5 )$$

Formula (4) shows that if the initial heat disturbance in the cylindrically symmetric task is specified in the form of excessive heat energy in a homogeneous medium, the asymptotic behavior of temperature is determined solely by the thermal conductivity of the medium.

In the considered case, the medium is heterogeneous (FIG. 1): a borehole fluid (0<r<r_{ci}, r_{ci} is an inner radius of the casing), a casing (r_{ci}<r<r_{co}, r_{co} is an outer radius of the casing), a cement slurry (r_{co}<r<r_{w}, r_{w}—is the radius of the borehole) and rock (r_{w}<r) have significantly different thermal properties. However, as shown by numerical calculations, asymptotic formula (4) describes quite accurately changes in the borehole temperature with time. This is explained by the fact that at large times the increase in the radius of the heated area is determined solely by the thermal conductivity of the rock, and the radial variations in the temperature near the borehole are small.

In the considered case, the excess thermal energy Q is a product of the cement slurry hydration heat Q_{c} (J/m³) and a volume of the annulus Vₐ (m³ per one meter of the borehole length):

$$\begin{matrix}Q ( z ) = {Q}_{c} \cdot {V}_{a} ( z ) & ( 6 ) \\ {V}_{a} ( z ) = \frac{π}{L} \cdot {\int }_{z - \frac{L}{2}}^{z + \frac{L}{2}} ( {{r}_{w} ( z )}^{2} - {r}_{co}^{2} ) dz & ( 7 )\end{matrix}$$

where L is a depth interval used for averaging the volume of the annulus. Typical value of this parameter is L=2÷3 m, it provides a vertical resolution of the present method. Value L is determined by the smoothing effect of the vertical conductive heat transfer in the rock and typical time of measurements.

If undisturbed temperature T_{f} (z) of rock at analyzed depth z is known, thermal conductivity of rock λ(z) is determined by the value of function F(z,t) at large times (t>t₀):

$$\frac{{Q}_{c} \cdot {V}_{a} ( z )}{4 π \cdot t \cdot [ {T}_{DTS} ( z , t ) - {T}_{f} ( z ) ]} = F ( z , t ) {⇒}^{t > {t}_{m}} λ ( z ) \qquad ( 8 )$$

Time tₘ should be greater than the duration of the main cement slurry hydration stage and the time at which asymptotic formula (4) becomes applicable. Typical value of tₘ=100 is 150 hours.

Generally, undisturbed temperature of rock, T_{f}(z), is unknown, and the thermal conductivity of rock is proposed to be determined in the following way.

The measured values of temperature at t>tₘ are approximated by asymptotic formula (at hydration time of more than 100 hours)

T(z,t)=T_{f}(z)+C(z)·t⁻¹ (9)

The linear regression method is used to determine parameter C(z) and rock temperature T_{f}(z), which is not used in the subsequent calculation of thermal conductivity.

Parameter C is used for calculation of the thermal conductivity of rock by the formula:

$$λ ( z ) = \frac{{Q}_{c} \cdot {V}_{a} ( z )}{4 π \cdot C ( z )} \qquad ( 10 )$$

The present method of determining thermal conductivity of rock has been tested on synthetic cases prepared using Comsol commercial simulator. FIG. 1 shows the geometry of a cylindrically symmetric model, which was used in the calculations.

The internal and external radii of the casing are r_{ci}=0.1 m, r_{co}=0.11 m, the borehole radius r_{w}=0.18 m, the outer radius of the computational domain rₑ=20 m. The thermal properties of the borehole fluid used in the calculations (virtual value of the thermal conductivity, which takes into account the free heat of the fluid), the casing, cement slurry and rock are presented in Table below.

TABLE

| | TC, W/m/K | ρ, kg/m³ | C, J/kg/K |
|---|---|---|---|
| Fluid | 3 (virtual value) | 1000 | 4000 |
| String | 30 | 7800 | 500 |
| Grout | 0.8 | 2600 | 900 |
| Rock | 1 and 2 | 2700 | 1000 |

The following analytical formula was used for cement hydration heat release q(t):

$$q ( t ) = \frac{Q}{\sqrt{π} \cdot {t}_{1}} \cdot exp [ - {( \frac{t - {t}_{0}}{{t}_{1}} )}^{2} ] , \\ {Q}_{c} = {\int }_{0}^{∞} q ( t ) dt$$

Calculations were made for the following parameters that define release of heat at cement hydration: Q_{c}=1.5·10⁸ J/m³, t₀=6 hours, t₁=8 hours.

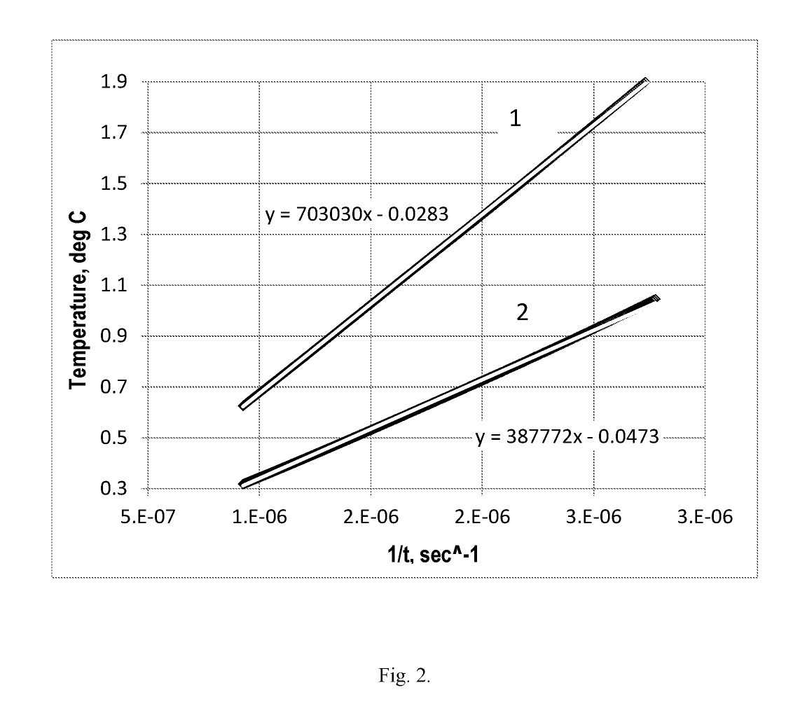

FIG. 2 shows the calculated dependence of the temperature in the annulus at a distance of 0.13 m from the borehole axis on inverse time t⁻¹, c⁻¹ (time interval 300-100 hours from the beginning of grout hydration) for two values of thermal conductivity of rock: λ=1 and 2 W/m/K The regression equations and white lines correspond to the linear approximation of the numerical simulation results. The initial temperature was assumed equal to zero. In the time interval the calculated dependences are well described by straight lines (9). The regression equations shown in the Figure have free members close to zero (0.0283 and 0.0473), this corresponding to zero initial temperature, and substitution in equation (10) of coefficients of regression equation (C(1 W/m/K)=703030 and C(2 W/m/K)=387772) gives the following values of the thermal conductivity of rock: 1.07 and 1.96 W/m/K.

The accuracy of determining the thermal conductivity of rock can be improved and the required time of temperature measurement can be significantly reduced by utilizing numerical simulation of cement hydration process in a borehole for solving the inverse task.

1. A method for determining a thermal conductivity profile of a rock formation surrounding a borehole, the method comprising:
lowering a casing with temperature sensors attached to its outer surface into the borehole,
injecting a cement slurry into an annulus between the casing and a borehole wall,
during said injecting and hardening of the cement slurry measuring temperature and determining the thermal conductivity of the rock formation surrounding the borehole by the formula:
$$λ ( z ) = \frac{{Q}_{c} \cdot {V}_{a} ( z )}{4 π \cdot C ( z )}$$
where λ(z) is a thermal conductivity of rock at depth z; Q_{c} is a cement hydration heat; Vₐ(z) is a volume of the annulus per meter of a borehole length at a depth z; C(z) is a coefficient determined by a linear regression method with approximation of the dependence of the measured downhole temperature T(z,t) on inverse time t⁻¹ by the asymptotic formula:
T(z,t)=T_{f}(z)+C(z)·t⁻¹
where T_{f}(z) is temperature of the rock formation at the depth z.

2. The method of claim 1, wherein the temperature sensors are a fiber-optic sensor.

3. The method of claim 1, wherein a numerical simulation of cement hydration in the borehole is used for determining the thermal conductivity of rock.
